(19) United States
(12) Patent Application Publication
(10) Pub. No.: US 2015/0163165 A1
(43) Pub. Date: Jun. 11, 2015

(54) METHOD AND DEVICE FOR PROVIDING SERVICE FILE AND COMPUTER STORAGE MEDIUM

(71) Applicant: TENCENT TECHNOLOGY (SHENZHEN) COMPANY LIMITED

(72) Inventor: Gang LIU, Shenzhen (CN)

(21) Appl. No.: 14/618,577

(22) Filed: Feb. 10, 2015

Related U.S. Application Data
(63) Continuation of application No. PCT/CN2013/079578, filed on Jul. 18, 2013.

(30) Foreign Application Priority Data
Aug. 17, 2012 (CN) 201210294624.X

(51) Int. Cl. H04L 12/927; H04L 29/06; H04L 12/911

(52) U.S. Cl. CPC H04L 47/803; H04L 47/783; H04L 67/42

(57) ABSTRACT

The present disclosure provides a method and device for providing a service file, and the method includes: a service file acquisition request sent by a client is received; a service file is acquired according to the service file acquisition request; level information of the client is acquired; and the service file is transmitted to the client, and a transmission rate of the service file is controlled according to the level information. The present disclosure enables a high-level client to obtain a higher download rate.

### CROSS-REFERENCE TO RELATED PATENT APPLICATIONS

The present application is a U.S. continuation application under 35 U.S.C. §111(a) claiming priority under 35 U.S.C. §§120 and 365(c) to International Application No. PCT/CN2013/079578 filed Jul. 18, 2013, which claims priority of Chinese Patent Application No. 201210294624.X, entitled “Method and Device for Providing Service File and Computer Storage Medium” filed on Aug. 17, 2012, the disclosures of which are incorporated by reference herein in their entirety.

### TECHNICAL FIELD

The present disclosure relates to the field of computers, and in particular to a method and device for providing a service file and a computer storage medium.

### BACKGROUND

A conventional server is desired to provide periodically or non-periodically a client of a user with a service file (for example, a game file), so as to update the client or maintain a stable operation of the client. At present, there are quite a number of servers providing a client of a user with a service file by using a Peer to Server & Peer (P2SP) technique, wherein the P2SP technique is a combination of a Peer to Server (P2S) technique and a Peer to Peer (P2P) technique.

The above technical solution has the following drawbacks:

(1) The P2PS technique adopts an approach of using multiple sources and P2P, and is thus a best-effort service approach, of which the download rate and quality cannot be guaranteed, particularly during a peak time when a service file is released or a patch is updated, plenty of users compete simultaneously against each other to use bandwidth resources of a server, and for those in low bandwidths, they may not be able to defeat other users;

(2) The download quality of a service file has no correlation with attributes of a client itself, but has correlation with network environment of the client, and users of different levels are provided with the same download service, thus users can not be stimulated to adopt a higher service level, and the attractiveness of the service to privileged users may not be improved.

(3) If multi-source P2S cannot take effect, Uniform Resource Locators (URLs) queried from the server are all dead links, and if a P2P node is invalid, it cannot be ensured that download of a service file is certainly successful.

The download of a service file is an important step to ensure that a client operates stably and is in a newest status, and experiences in this step are of great importance to increase customer retention. In general, the higher the level of a user, the stronger his intention and ability to pay, thus as a return and stimulation, and also as a way of increasing the attractiveness of a service, it is desired to provide a service file download with better quality and better experiences to this kind of users.

At present, the slow updating of a service file already becomes an important reason why a user abandons the usage of a corresponding client. Generally, the updating of a service file includes updates regarding aspects such as a picture, effect of an equipment, item, chat and the like. The updating of a service file generally involves a download of the service file, thus it is of great importance to ensure the download quality of the service file.

Therefore, it is necessary to provide a new technical solution to solve the above technical problems.

### SUMMARY

In view of the above, an objective of the present disclosure is to provide a method and device for providing a service file and a computer storage medium, which can control the rate of transmitting the service file to a client according to the level of the client.

To solve the aforementioned problems, technical solutions of the embodiments of the present disclosure are as follows.

A method for providing a service file, including: a service file acquisition request sent by a client is received; a service file is acquired according to the service file acquisition request, wherein the service file is configured to provide the client with an update; an account number of the client is collected, and level information of the client is acquired according to the account number; and the service file is transmitted to the client, and a transmission rate of the service file is controlled according to the level information.

A method for providing a service file, including: a service file acquisition request sent by a client is received; a service file is acquired according to the service file acquisition request; level information of the client is acquired; and the service file is transmitted to the client, and a transmission rate of the service file is controlled according to the level information.

A device for providing a service file, including: a request information reception module configured to receive a service file acquisition request sent by a client; a service file acquisition module configured to acquire a service file according to the service file acquisition request; a level information acquisition module configured to acquire level information of the client; and a service file transmission module configured to transmit the service file to the client and control a transmission rate of the service file according to the level information.

A computer storage medium, in which a computer instruction is stored, wherein the computer instruction is configured to implement the aforementioned method for providing a service file.

Compared to the prior art, the present disclosure can control rates of transmitting a game service file to different clients according to different levels of these clients, and a client of a user with a higher level may acquire a higher rate of downloading a game service file, thus improving the attractiveness of an online game to users. In addition, since transmission rate of a game service file is monitored and the transmission rate of the game service file is controlled according to the monitoring result, it is enabled that the rate of transmitting the game service file to a user is effectively maintained at the vicinity of a preset transmission rate value instead of reaching the preset transmission rate value only in certain period of time.

In order to make above content of the present disclosure more obvious and understandable, specific embodiments will be elaborated below with reference to the accompanying drawings.

### BRIEF DESCRIPTION OF THE DRAWINGS

FIG. 1 is a block diagram of a device for providing a service file according to an embodiment of the present disclosure;

FIG. 2 is a block diagram of a service file transmission module in FIG. 1;

FIG. 3 is a flow chart of the method for providing a service file according to an embodiment of the present disclosure; and

FIG. 4 is a flow chart of the step of the transmitting the service file to the client and controlling a transmission rate of the service file according to the level information in FIG. 3.

### DETAILED DESCRIPTION

The below embodiments are described with reference to the accompanying drawings, so as to exemplify specific embodiments of the present disclosure.

In the following description, unless otherwise stated, the specific embodiments of the present disclosure will be described with reference to steps and their symbols of operations implemented by one or more computer(s)/mobile device(s). Therefore, it will be known that these steps and operations, of which are mentioned several times that they are implemented by a computer/mobile device, include electronic signals, in the form of structured data, manipulated by a processing unit of a computer/mobile device. The manipulation converts the data or maintains the data into positions in a memory of the computer/mobile device, the manipulation may be reconfigured or change the operation of the computer/mobile device in a way known by those skilled in the art. The data structure maintained by the data is a physical location of the memory, and the physical location has specific features defined by the data format. However, the principle of the present disclosure is explained by the above description, which is not intended to limit the present disclosure, and those skilled in the art will understand that all the various steps and operations may also be implemented in a hardware.

The principle of the present disclosure is operated by using many other general-purposed or specific-purposed computing systems, communication environments or configurations. Examples of well-known computing systems, environments and configurations suitable for embodiments of the present disclosure include, but are not limited to: systems based on a tablet computer, mobile phone, personal computer, server, multi-processor system and microcomputer, main-frame computer, and a distributed computing environment which includes any of the above systems or devices.

The term “module” or “unit” used herein refers to a software object or routine implemented on the computing system. Here different assemblies, modules, engines and services may be implemented as objects or processes implemented on the computing system. But the system and method described here are preferably implemented as a software, and implementations on a hardware is also possible and is considered.

The method and device for providing a service file according to embodiments of the present disclosure may be operated in a computer/mobile device, wherein the computer may be a system consisting of one or more of a personal computer, server and the like, and the mobile device may be a system consisting of one or more of a tablet computer, mobile phone, Personal Digital Assistant (PDA), laptop computer and the like. The computer/mobile device may include any combination of a processor, storage, sensor, switching device, power supply, clock signal generator and input/output device. The any combination of a processor, storage, sensor, switching device, power supply, clock signal generator and input/output device in the above computer/mobile device is used to implement steps in the method and functions in the device of the embodiments of the present disclosure.

In the embodiment, software program instructions corresponding to the device are stored in a storage and processed by a processor, so as to implement process management in an operation system.

In addition, the storage includes a computer-readable storage medium, which may be a magnetic disk, optical disk, Read Only Memory (ROM) or Random Access Memory (RAM) and the like.

The technical problem to be solved by the present disclosure is how to allocate a bandwidth (control transmission rate) for transmitting/transmission of a service file (for example, a network file or game file) according to level or rank of a client of a user so that the client of a user with a higher level can obtain a higher rate of downloading the service file (for example, a game file). When applied in an online game for example, the method according to the present disclosure may enhance experiences of a user and improve attractiveness of an online game to its users. To this end, the method and device for providing a service file according to embodiments of the present disclosure identify the level of a client, and then differentiate rates of transmitting the service file to the client of the user, so that a bandwidth is allocated to the transmission of the service file according to the level of the client, and thus a higher-level client may acquire a higher rate of downloading (receiving) the service file, so as to stimulate a user to adopt a higher level.

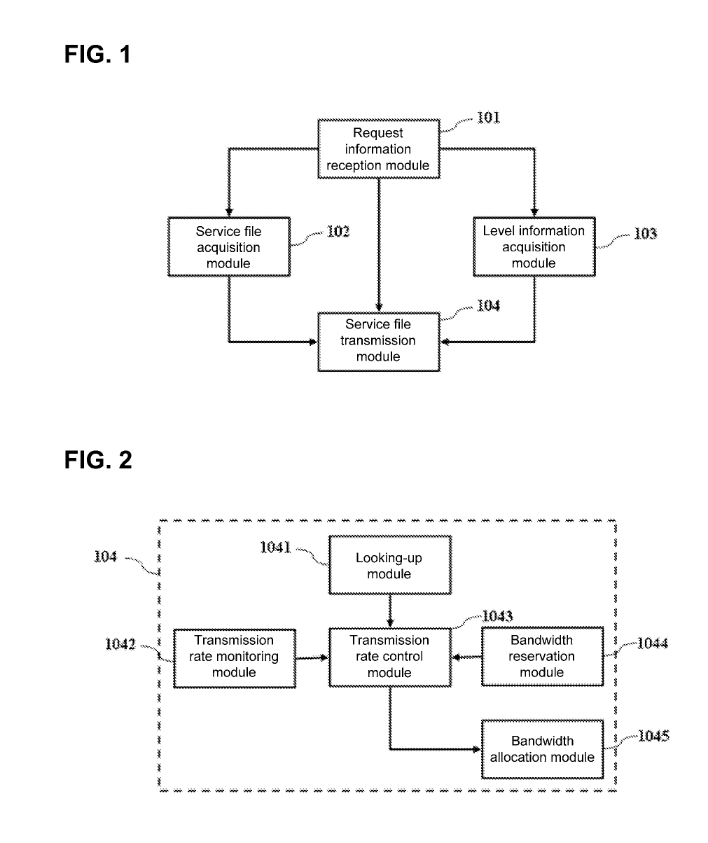

Referring to FIG. 1 and FIG. 2, FIG. 1 is a block diagram of a device for providing a service file according to an embodiment of the present disclosure; and FIG. 2 is a block diagram of a service file transmission module 104 in FIG. 1;

The device for providing a service file according to the embodiment of the present disclosure includes a request information reception module 101, a service file acquisition module 102, a level information acquisition module 103 and a service file transmission module 104.

The request information reception module is configured to receive a service file acquisition request sent by a client. Specifically, the request information reception module 101 is configured to: communicate with the client, receive the service file acquisition request from the client, and transmit feedback information corresponding to the service file acquisition request to the client.

The service file acquisition module 102 is configured to acquire a service file according to the service file acquisition request. The device for providing a service file according to the embodiment of the present disclosure may further include a storage module (not shown in the drawing) configured to store the service file, wherein the service file may be configured to provide the client with an update or an installation. The service file is acquired from the storage module by the service file acquisition module 102.

The level information acquisition module 103 is configured to acquire level information of the client. The level information acquisition module may further be configured to collect information of the client, and the information of the client may an account number of a user; the level information acquisition module 103 may acquire an account number of a user by monitoring whether the client is logged in. The level information acquisition module 103 may be further configured to identify (determine) level of the client according to the account number and generate the level information according to an identification result.

The service file transmission module 104 is configured to transmit the service file to the client and control a transmission rate of the service file according to the level information. Specifically, the service file transmission module 104 may transmit the service file for example by using the client, in order to make the rate at which the service file transmission module 104 transmits the service file to the client reach a preset transmission rate value, the service file transmission module 104 may ensure and control the transmission rate of the service file by the following approaches: 1. priority of the transmission of the service file is adjusted according to the level of the client, and for a client with a higher level, the service file will be sent preferentially; 2. the service file is copied to other nodes (database) so as to generate more resource links regarding the service file, the service file is transmitted to the client by using these resource links regarding the service file, and the transmission rate of the service file is controlled by transmitting different numbers of resource links to the client.

In the device for providing a service file according to the embodiment of the present disclosure, the service file transmission module 104 includes a looking-up module 1041 and a transmission rate control module 1043.

The looking-up module 1041 is configured to look up a preset transmission rate value according to the level information.

The transmission rate control module 1043 is configured to transmit the service file to the client according to the preset transmission rate value.

In the device for providing a service file according to the embodiment of the present disclosure, in order to further ensure that the rate of downloading (receiving) the service file by the client maintains constant during the transmission of the service file, the transmission rate of the service file is monitored, an additional bandwidth is allocated to be used by the client when the transmission rate of the service file is low, or the supply of the bandwidth allocated to the client is reduced when the transmission rate of the service file exceeds the preset transmission rate value, so that the rate of acquiring the service file by the client maintains constant.

In the technical solution according to the embodiment of the present disclosure, the service file transmission module 104 further includes a transmission rate monitoring module 1042.

The transmission rate monitoring module 1042 is configured to monitor an actual transmission rate value of the service file during a transmission process and generate a monitoring result.

The transmission rate control module 1043 is further configured to adjust the transmission rate according to the monitoring result so that the actual transmission rate value of the service file is in accordance with the preset transmission rate value.

In the device for providing a service file according to embodiment of the present disclosure, the transmission rate control module 1043 is further configured to: when the monitoring result is that the actual transmission rate value is smaller than the preset transmission rate value, improve the transmission rate; and when the monitoring result is that the actual transmission rate value is greater than the preset transmission rate value, lower the transmission rate.

In the device for providing a service file according to the embodiment of the present disclosure, the transmission rate control module 1043 is further configured to: when the monitoring result is that the actual transmission rate value is smaller than the preset transmission rate value, allocate a reserved bandwidth to the transmission of the service file; and when the monitoring result is that the actual transmission rate value is greater than the preset transmission rate value, reduce a bandwidth of the transmission of the service file. Specifically, in the device for providing a service file according to the embodiment of the present disclosure, the service file transmission module 104 further includes a bandwidth reservation module 1044 and a bandwidth allocation module 1045. The bandwidth reservation module 1044 is configured to reserve a bandwidth for the service file. The bandwidth allocation module 1045 is configured to allocate a bandwidth to the client according to the monitoring result. In this way, it is enabled that the rate of transmitting the service file to a user is effectively maintained at the vicinity of a preset transmission rate value instead of reaching the preset transmission rate value only in certain period of time.

The device for providing a service file according to the embodiment of the present disclosure may further include a transmission rate setting module (not shown in the drawing). The transmission rate setting module is configured to set a preset transmission rate value of the service file, which is associated with the level of the client.

In addition, since the client can download (receive) a service file not only by the P2S technique but also by the P2P technique, a rate at which the service file is transmitted to the client may not be the same as a rate at which the service file is received by the client. In order to more accurately learn and control the rate of acquiring the service file by the client, the transmission rate monitoring module 1042 transmits a transmission rate acquisition request to the client and receives a feedback of the client through the request information reception module 101, so as to learn a practical rate of acquiring the service file by the client and generate a monitoring result. The bandwidth allocation module 1045 allocates a bandwidth to the client according to the monitoring result, i.e., when a practical rate of acquiring the service file by the client is greater than the rate of transmitting the service file to the client by the service file transmission module 104, the bandwidth allocation module 1045 allocates a relatively small bandwidth to the client; when the practical rate of acquiring the service file by the client is smaller than the rate of transmitting the service file to the client by the service file transmission module 104, the bandwidth allocation module 1045 allocates a relatively great bandwidth to the client. In this way, in the case that the client uses the P2P technique as an approach for acquiring the service file, the above technical solution facilitates saving a bandwidth for transmitting a service file to the client, and the saved bandwidth may be used as a reserved bandwidth provided to other clients.

The present disclosure can control rates of transmitting a service file to different clients according to different levels of these clients, and a client of a user with a higher level may acquire a higher rate of downloading a service file, thus improving the attractiveness of an online game to users. In addition, since transmission rate of a service file is monitored and the transmission rate of the service file is controlled according to the monitoring result, it is enabled that the rate of transmitting the service file to a user is effectively maintained at the vicinity of a preset transmission rate value instead of reaching the preset transmission rate value only in certain period of time.

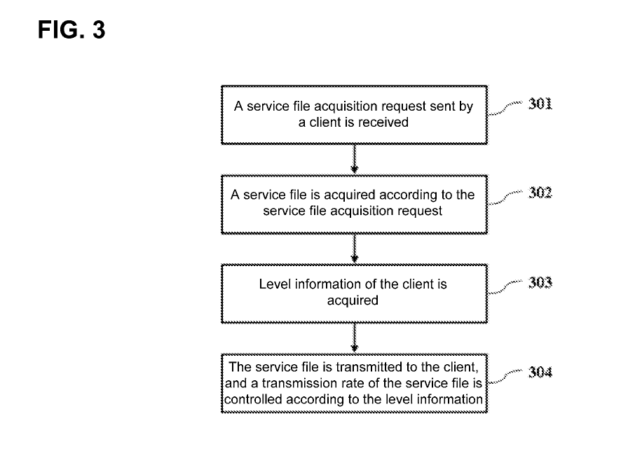

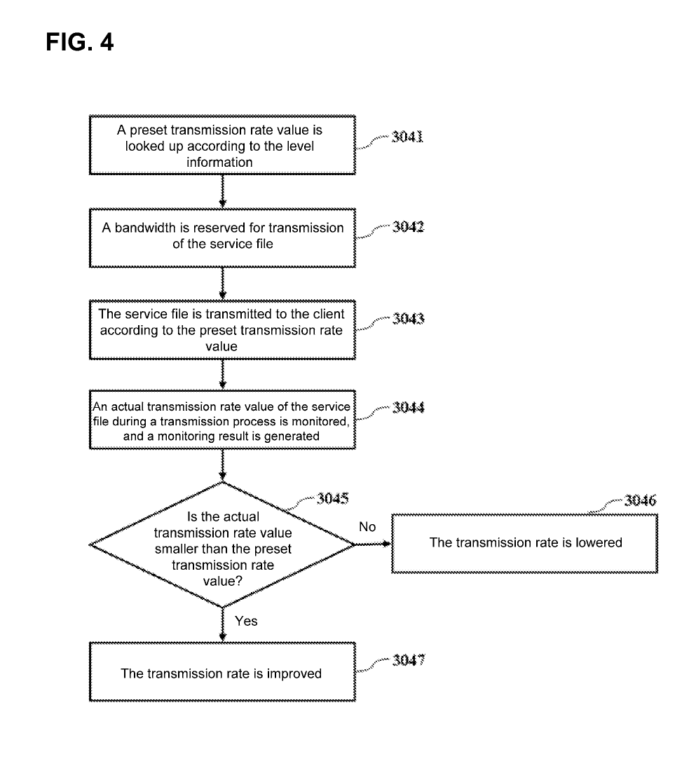

Referring to FIG. 3 and FIG. 4, FIG. 3 is a flow chart of the method for providing a service file according to an embodiment of the present disclosure; and FIG. 4 is a flow chart of the step of the transmitting the service file to the client and controlling a transmission rate of the service file according to the level information in FIG. 3. The method for providing a service file according to the embodiment of the present disclosure is implemented by the device for providing a service file according to the embodiment of the present disclosure.

The method for providing a service file according to the embodiment of the present disclosure includes the following steps:

Step 301, the request information reception module 101 receives a service file acquisition request sent by the client. Specifically, the request information reception module 101 communicates with the client, receives the service file acquisition request from the client, and transmits feedback information corresponding to the service file acquisition request to the client.

Step 302, the service file acquisition module 102 acquires a service file according to the service file acquisition request. The service file is configured to provide the client with an update or an installation. The service file is read from the storage module by the service file acquisition module 102.

Step 303, the level information acquisition module 103 acquires level information of the client. The level information acquisition module may further collect information of the client, and the information of the client may an account number of a user; the level information acquisition module 103 may acquire an account number of a user by monitoring whether the client is logged in. The level information acquisition module 103 may further identify (determine) level of the client according to the account number and generate the level information according to an identification result.

Step 304, the service file transmission module 104 transmits the service file to the client and control a transmission rate of the service file according to the level information. Specifically, the service file transmission module 104 transmits the service file to the client by using the P2S technique, in order to make the rate at which the service file transmission module 104 transmits the service file to the client reach a preset transmission rate value, the service file transmission module 104 may ensure and control the transmission rate of the service file by the following approaches: 1. priority of the transmission of the service file is adjusted according to the level of the client, and for a client with a higher level, the service file will be sent preferentially; 2. the service file is copied to other nodes (database) so as to generate more resource links regarding the service file, the service file is transmitted to the client by using these resource links regarding the service file, and the transmission rate of the service file is controlled by transmitting different numbers of resource links to the client.

In the method for providing a service file according to the embodiment of the present disclosure, the step that the service file is transmitted to the client and a transmission rate of the service file is controlled according to the level information includes:

Step 3041, the looking-up module 1041 looks up a preset transmission rate value according to the level information.

Step 3043, the transmission rate control module 1043 transmits the service file to the client according to the preset transmission rate value.

In the method for providing a service file according to the embodiment of the present disclosure, in order to further ensure that the rate of downloading (receiving) the service file by the client maintains constant during the transmission of the service file, the transmission rate of the service file is monitored, an additional bandwidth is allocated to be used by the client when the transmission rate of the service file is low, or the supply of the bandwidth allocated to the client is reduced when the transmission rate of the service file exceeds the preset transmission rate value, so that the rate of acquiring the service file by the client maintains constant.

In the method for providing a service file according to the embodiment of the present disclosure, the step that the service file is transmitted to the client and a transmission rate of the service file is controlled according to the level information further includes:

Step 3044, the transmission rate monitoring module 1042 monitors an actual transmission rate value of the service file during a transmission process and generate a monitoring result.

Steps 3045, 3046, 3047, the transmission rate control module 1043 adjusts the transmission rate according to the monitoring result so that the actual transmission rate value of the service file is in accordance with the preset transmission rate value.

In the method for providing a service file according to the embodiment of the present disclosure, when the monitoring result is that the actual transmission rate value is smaller than the preset transmission rate value, the transmission rate control module 1043 improves the transmission rate; and when the monitoring result is that the actual transmission rate value is greater than the preset transmission rate value, the transmission rate control module 1043 lowers the transmission rate.

In Steps 3045, 3046, 3047, when the monitoring result is that the actual transmission rate value is smaller than the preset transmission rate value, the transmission rate control module 1043 allocates a reserved bandwidth to the transmission of the service file; and when the monitoring result is that the actual transmission rate value is greater than the preset transmission rate value, the transmission rate control module 1043 reduces a bandwidth of the transmission of the service file.

In the method for providing a service file according to the embodiment of the present disclosure, the step that the service file is transmitted to the client and a transmission rate of the service file is controlled according to the level information further includes:

Step 3042, the bandwidth reservation module 1044 reserves a bandwidth for the service file.

In Steps 3046 and 3047, the bandwidth allocation module 1045 allocates a bandwidth to the client according to the monitoring result. In this way, it is enabled that the rate of transmitting the service file to a user is effectively maintained at the vicinity of a preset transmission rate value instead of reaching the preset transmission rate value only in certain period of time.

The method for providing a service file according to the embodiment of the present disclosure may further includes the following step:

A preset transmission rate value of the service file is set in advance by using a transmission rate setting module, and the preset transmission rate value is associated with the level of the client.

In addition, in the method for providing a service file according to the embodiment of the present disclosure, since the client can download (receive) a service file not only by the P2S technique but also by the P2P technique, a rate at which the service file is transmitted to the client may not be the same as a rate at which the service file is received by the client. In order to more accurately learn and control the rate of acquiring the service file by the client, the transmission rate monitoring module 1042 transmits a transmission rate acquisition request to the client and receives a feedback of the client through the request information reception module 101, so as to learn a practical rate of acquiring the service file by the client and generate a monitoring result. The bandwidth allocation module 1045 allocates a bandwidth to the client according to the monitoring result, i.e., when a practical rate of acquiring the service file by the client is greater than the rate of transmitting the service file to the client by the service file transmission module 104, the bandwidth allocation module 1045 allocates a relatively small bandwidth to the client; when the practical rate of acquiring the service file by the client is smaller than the rate of transmitting the service file to the client by the service file transmission module 104, the bandwidth allocation module 1045 allocates a relatively great bandwidth to the client. In this way, in the case that the client uses the P2P technique as an approach for acquiring the service file, the above technical solution facilitates saving a bandwidth for transmitting a service file to the client, and the saved bandwidth may be used as a reserved bandwidth provided to other clients.

The present disclosure can control rates of transmitting a service file to different clients according to different levels of these clients, and a client of a user with a higher level may acquire a higher rate of downloading a service file, thus improving the attractiveness of an online game to users. In addition, since transmission rate of a service file is monitored and the transmission rate of the service file is controlled according to the monitoring result, it is enabled that the rate of transmitting the service file to a user is effectively maintained at the vicinity of a preset transmission rate value instead of reaching the preset transmission rate value only in certain period of time.

The computer storage medium according to an embodiment of the present disclosure stores a computer program therein, wherein the computer program is configured to implement the above method for providing a service file, i.e., the computer program may include instructions of service file providing functions implemented by a computer, and the functions include the above step 301 to step 304.

It should be noted that those skilled in the art will appreciate that all or part of the steps in the method according to the above embodiments may be implemented by related hardwares under instructions of a program, which is stored in a computer readable storage medium, and when the program is implemented, the steps in the method according to the above embodiments may be included. Wherein the storage medium may be a magnetic disk, optical disk, ROM or RAM and the like

All functional units in the embodiments of the present disclosure may be integrated into one processing module, they may exist in the form of a respective unit, and they may exist in the form of two or more units being integrated into one module. The above integrated module may be implemented in the form of not only a hardware but also a software functional module. If the integrated module is implemented in the form of a software functional module and sold or used as an independent product, it may also be stored in a computer-readable storage medium. The aforementioned storage medium may be an ROM, magnetic disk or optical disk and the like. The above device or system may implement a method in a corresponding embodiment of the method.

To sum up, though the present disclosure is disclosed as above based on preferable embodiments, the above preferable embodiments are not intended to limit the present disclosure, and various changes and modifications may be made by those skilled in the art without departing from the spirit and scope of the present disclosure, thus the scope of protection of the present disclosure is the scope defined by the claims.

1. A method for providing a service file, comprising:
receiving a service file acquisition request sent by a client;
acquiring a service file according to the service file acquisition request, wherein the service file is configured to provide the client with an update;
collecting an account number of the client, and acquiring level information of the client according to the account number; and
transmitting the service file to the client, and controlling a transmission rate of the service file according to the level information.

2. The method for providing a service file according to claim 1, wherein the step of transmitting the service file to the client and controlling a transmission rate of the service file according to the level information comprises:
looking up a preset transmission rate value according to the level information; and
transmitting the service file to the client according to the preset transmission rate value.

3. The method for providing a service file according to claim 2, wherein the step of transmitting the service file to the client and controlling a transmission rate of the service file according to the level information further comprises:
monitoring an actual transmission rate value of the service file during a transmission process, and generating a monitoring result; and
adjusting the transmission rate according to the monitoring result, so that the actual transmission rate value of the service file is in accordance with the preset transmission rate value.

4. The method for providing a service file according to claim 3, wherein the step of adjusting the transmission rate according to the monitoring result comprises:
improving the transmission rate when the monitoring result is that the actual transmission rate value is smaller than the preset transmission rate value; and
lowering the transmission rate when the monitoring result is that the actual transmission rate value is greater than the preset transmission rate value.

5. The method for providing a service file according to claim 4, wherein the step of transmitting the service file to the client and controlling a transmission rate of the service file according to the level information further comprises:
reserving a bandwidth for transmission of the service file.

6. The method for providing a service file according to claim 5, wherein the step of improving the transmission rate comprises:
allocating a reserved bandwidth to the transmission of the service file;
and the step of lowering the transmission rate comprises:
reducing a bandwidth of the transmission of the service file.

7. A method for providing a service file, comprising:
receiving a service file acquisition request sent by a client;
acquiring a service file according to the service file acquisition request;
acquiring level information of the client; and
transmitting the service file to the client, and controlling a transmission rate of the service file according to the level information.

8. The method for providing a service file according to claim 7, wherein the step of transmitting the service file to the client and controlling a transmission rate of the service file according to the level information comprises:
looking up a preset transmission rate value according to the level information; and
transmitting the service file to the client according to the preset transmission rate value.

9. The method for providing a service file according to claim 8, wherein the step of transmitting the service file to the client and controlling a transmission rate of the service file according to the level information further comprises:
monitoring an actual transmission rate value of the service file during a transmission process, and generating a monitoring result; and
adjusting the transmission rate according to the monitoring result, so that the actual transmission rate value of the service file is in accordance with the preset transmission rate value.

10. The method for providing a service file according to claim 9, wherein the step of adjusting the transmission rate according to the monitoring result comprises:
improving the transmission rate when the monitoring result is that the actual transmission rate value is smaller than the preset transmission rate value; and
lowering the transmission rate when the monitoring result is that the actual transmission rate value is greater than the preset transmission rate value.

11. The method for providing a service file according to claim 10, wherein the step of transmitting the service file to the client and controlling a transmission rate of the service file according to the level information further comprises:
reserving a bandwidth for transmission of the service file.

12. The method for providing a service file according to claim 11, wherein the step of improving the transmission rate comprises:
allocating a reserved bandwidth to the transmission of the service file;
and the step of lowering the transmission rate comprises:
reducing a bandwidth of the transmission of the service file.

13. A device for providing a service file, comprising:
a request information reception module configured to receive a service file acquisition request sent by a client;
a service file acquisition module configured to acquire a service file according to the service file acquisition request;
a level information acquisition module configured to acquire level information of the client; and
a service file transmission module configured to transmit the service file to the client and control a transmission rate of the service file according to the level information.

14. The device for providing a service file according to claim 13, wherein the service file transmission module comprises:
a looking-up module configured to look up a preset transmission rate value according to the level information; and
a transmission rate control module configured to transmit the service file to the client according to the preset transmission rate value.

15. The device for providing a service file according to claim 14, wherein the service file transmission module further comprises:
a transmission rate monitoring module configured to monitor an actual transmission rate value of the service file during a transmission process and generate a monitoring result; and
the transmission rate control module is further configured to adjust the transmission rate according to the monitoring result, so that the actual transmission rate value of the service file is in accordance with the preset transmission rate value.

16. The device for providing a service file according to claim 15, wherein the transmission rate control module is further configured to: when the monitoring result is that the actual transmission rate value is smaller than the preset transmission rate value, improve the transmission rate; and when the monitoring result is that the actual transmission rate value is greater than the preset transmission rate value, lower the transmission rate.

17. The device for providing a service file according to claim 16, wherein the service file transmission module further comprises:
a bandwidth reservation module configured to reserve a bandwidth for transmission of the service file.

18. The device for providing a service file according to claim 17, wherein the transmission rate control module is further configured to: when the monitoring result is that the actual transmission rate value is smaller than the preset transmission rate value, allocate a reserved bandwidth to the transmission of the service file; and when the monitoring result is that the actual transmission rate value is greater than the preset transmission rate value, reduce a bandwidth of the transmission of the service file.
